(19) United States
(12) Patent Application Publication
(10) Pub. No.: US 2007/0167347 A1
(43) Pub. Date: Jul. 19, 2007

(54) Solid softener composition

(75) Inventors: Manlio Gallotti, Sao Paulo-SP (BR); George Nunes, Sao Paulo-SP (BR); Gustavo Kume, Sao Paulo-SP (BR)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant International Ltd.

(21) Appl. No.: 10/900,702

(22) Filed: Jul. 28, 2004

(30) Foreign Application Priority Data
Jul. 29, 2003 (EP) 03017171.4

(51) Int. Cl. C11D 3/00

(52) U.S. Cl. 510/515

(57) ABSTRACT

The present patent relates to a solid softener composition suitable for treatment of fabrics and garments, composed by: a) a cationic compound with softener properties; b) an organic/inorganic carrier system; c) a solubilizer system; and d) optionally a fatty system. Methods for production and application of the softener composition are also disclosed.

This invention relates to a solid softener composition suitable for treatment of textile articles in domestic, institutional and/or industrial applications.

It is well known that textiles which have been washed, either in automatic or manual washing processes, and particularly those made of cellulose fibers, present a very unpleasant touch after drying. This undesired hardened feel can be overcome by treating the garments after washing in a rinsing bath with conditioning products.

Those conditioning compositions are generally liquid dispersions of cationic compounds that are delivered into the rinsing bath through a dispenser, in an automatic process, or directly, in a manual process. Industrial production of liquid softeners, however, demand a high amount of water and expensive packages.

Powder, granular and tablet softener compositions, besides being very easy-dosed, substantially decrease the costs of packaging and transportation of the final product, once it makes possible to deliver it with higher concentrations and lower volumes. That reduction, plus the reduction of the water used in the formulation, leads to the main advantage of solid softeners: a decrease of the negative impact on the environment caused by the consumption of millions of liters of water in liquid softener production and by the discharge of tons of plastic bottles every year.

As a complementary advantage, this way of formulation makes feasible the commercialization of some actives and additives that are unstable when present in water based products. Moreover, for some cationic molecules such as Ester Quats, a solid formulation can improve the storage stability. Solid formulations also allow the use of products that are incompatible in liquid formulations.

Despite the many advantages listed above, it is still a challenge to develop a formulation of a solid softener that has a performance comparable to a liquid softener with the same kind and amount of active content. Sensorial panel tests carried out for the elaboration of this patent proved that the final softening effect on cotton towels is dramatically dependent on the carrier system used for production of the solid formulation. Based on these results, it is disclosed in the present patent a carrier system where organic and inorganic materials are synergistically combined to minimize the negative impact on final softening, due to solid deposition on fibers and/or problems of cationic active release from carriers. The correct association between different organic and inorganic solid materials in the carrier system allows the balance of its adsorptive characteristics and solubility behaviour. Furthermore, the correct balance is essential to reach the necessary performance characteristics associated to flowability, storage stability, water release profile of the active content and to minimize adsorption competition between the target cellulosic substrates of fabrics and the carrier for the cationic softener components during the application step.

Like most of the current commercial liquid softeners available in the market, the solid conditioning disclosed in the present invention has, as main actives, dialkylic cationic compounds, such as dialkyldimethyl ammonium salts, and/or diester quats of triethanolamine, diethanolamine or glycerine.

In the patent WO-0 244 310 it is described a method for producing and using a granular softener composed by a cationic compound, dispersing and disintegrating agents and only organic carriers. The use of solubilizers and of inorganic silicon dioxide as the solid phase of a powder laundry softener concentrate is disclosed in U.S. Pat. No. 4,589,989. In U.S. Pat. No. 5,505,866 it is divulged a solid particulate softener, made of biodegradable cationic esters and an acidic pH modifier, that can form chemically stable dilute or concentrated liquid softener compositions when added to water.

The present invention provides a solid softener composition that is suitable for treatment of fabrics and garments. In general, the softener composition here disclosed comprises:
a) a cationic compound of the formula 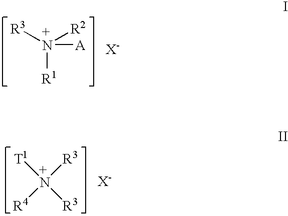
   wherein:
A is a group of the formulas —(CH₂)ₙ-Q-T¹ or 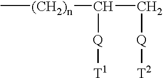
Q is selected from —O—C(O)—, —C(O)—O—, —O—C(O)—O—, —NR⁵—C(O)—, —C(O)—NR⁵—;
R¹ is (CH₂)n-Q-T² or T³ or R³;
R² is (CH₂)m-Q-T⁴ or T⁵ or R³;
R³ is H, C₁-C₆ alkyl, C₂-C₆ alkenyl or C₁-C₆ hydroxyalkyl;
R⁴ is T¹, T^{2,} T³, T⁴ or T⁵;
R⁵ is H, C₁-C₆ alkyl, C₂-C₆ alkenyl or C₁-C₆ hydroxyalkyl;
T¹, T², T³, T⁴, T⁵ are independently C₈-C₂₂-alkyl or C₈-C₂₂-alkenyl;
n and m are integers from 1 to 6; and
X⁻ is an anion, such as chloride, bromide, iodide, fluoride, sulfate, methosulfate, hydrogensulfate, carbonate, hydrogencarbonate, phosphate, mono- and di-hydrogenphosphate, pyrophosphate, metaphosphate, nitrate, phosphonate, methylphosphonate, methandisulfonate, methylsulfonate, ethansulfonate.

Preferred cationics of formula I are those wherein:
Q is selected from —O—C(O)—;
R¹ is (CH₂)n-Q-T² or T³ or R³;
R² is (CH₂)m-Q-T⁴ or T⁵ or R³;
R³ is C₁-C₆-alkyl, especially methyl, C₂-C₆-alkenyl or C₁-C₆-hydroxyalkyl, especially hydroxyethyl;
T¹, T², T³, T⁴, T⁵ are independently C₈-C₂₂-alkyl or C₈-C₂₂-alkenyl;
n and m are 1 or 2

Preferred cationics of formula 11 are those wherein
R⁴is T¹;
T¹ is C₁₂-C₁₈-alkyl;
R³ is methyl.
   b) A carrier system consisting of one or more organic solid material and at least one inorganic solid.
   c) A solubilizer system consisting of one or more solvents and at least one nonionic surfactant.
   d) Optionally a fatty system consisting of fatty alcohols, fatty acids, fatty esters or mixtures thereof.

As cationic compounds (a) there may be used the following ammonium quaternaries: dialkyl-dimethyl-ammonium, dialkyl-methyl-hydroxyalkyl-ammonium, dialkyl-dihydroxyalkyl-ammonium, dialkylamidopropyl-dimethyl-ammonium, dialkylamidopropyl-methyl-hydroxyalkyl-ammonium, dialkylamidopropyl-dihydroxyalkyl-ammonium, dialkoxyalkyl-dimethyl-ammonium, dialkoxyalkyl-methyl-hydroxyalkyl-ammonium, dialkoxyalkyl-dihydroxyalkyl-ammonium, dialkanoylethyl-dimethyl-ammonium, dialkanoylethyl-methyl-hydroxyalkyl-ammonium, dialkanoylethyl-dihydroxyalkyl-ammonium, dialkanoylpropyl-dimethyl-ammonium, monoalkanoylethyl-methyl-dihydroxyalkyl-ammonium, monoalkanoylethyl-trihydroxyalkyl-ammonium, trialkanoylethyl-hydroxyalkyl-ammonium, trialkanoylethyl-methyl-ammonium, dialkanoylpropyl-methyl-hydroxyalkyl-ammonium, dialkanoylpropyl-dihydroxyalkyl-ammonium,. Instead of alkyl these ammonium compounds may also have alkenyl groups or mixtures of both. The alkyl as well as the alkenyl groups may contain 8 to 22 carbon atoms. They may be linear or branched. Most preferred main cationic compounds are triethanolamine-diester quats, diethanolamine-diester quats. All mentioned ammonium compounds may contain any kind of anion, the preferred ones are chloride, bromide, acetate, lactate, sulfate, hydrogensulfate or methosulfate.

The claimed solid softener may contain these cationic compounds in an amount from 1 to 40%, preferentially from 2 to 20% by weight of the entire formulation.

The carrier system (b) is composed by one or more organic solid material and at least one inorganic solid material.

The organic material can be selected from the group of starch, starch derivatives, saccharides, disaccharides, oligosaccharides, polysaccharides, urea, urea derivatives, cellulose and cellulose derivatives. Examples of organic materials to be used as part of the carrier system in the present invention are corn starch, wheat flour, saccharose, glucose or urea. Solid carboxylic acids, such as citric acid, can also be used in the organic portion of carriers.

The inorganic portion may be composed by silicon dioxide, amorphous silica, precipitated silica, hydrated amorphous synthetic calcium silicate, hydrofobized precipitated silica, silica gel, sodium aluminium silicate, clay, zeolite, bentonite, layered silicate, caolim, sodium carbonate, sodium bicarbonate, sodium sulfate, sodium tripolyphosphate, sodium chloride, sodium silicate (water glass), magnesium chloride, calcium chloride, ammonium chloride, magnesium sulfate, calcium carbonate, calcium oxide, and/or calcium sulfate.

The claimed solid softener may contain the organic and inorganic carriers within the respective proportion of 99:1 to 20:80 by weight of the carrier system.

The carrier system comprises from 50 to 99%, preferably from 70 to 95% by weight of the entire formulation.

For the solubilizer system (c), suitable organic solvents are any mono- or polyhydric alcohols. Preference is given to using alcohols having from 1 to 4 carbon atoms, such as methanol, ethanol, propanol, isopropanol, straight chain and branched butanol, glycerol and mixtures of said alcohols. Other preferred alcohols are polyethylene glycols having a relative molecular mass below 2000. In particular, the use of polyethylene glycol having a relative molecular mass between 200 and 600 and in amounts up to 45% by weight, and of polyethylene glycol having a relative molecular mass between 400 and 600 in amounts from 5 to 25% by weight is preferred. Also the lower alkyl ether of ethylenglycol, propylenglycol, polyethylenglycol and polypropylenglycol can be used. An advantageous mixture of solvents consists of a monomeric alcohol, for example ethanol and polyethylene glycol in the ratio 0.5:1 to 1.2:1.

The claimed solid softener may contain these solvents in an amount from 1 to 15% by weight of the entire formulation.

The non-ionic synthetic organic detergents which are employed in the described compositions are generally the condensation product of an organic aliphatic or alkyl aromatic hydrophobic compound, both saturated or unsaturated, containing a terminal hydroxyl group and hydrophilic ethylene/propylene oxide groups. Such detergents are prepared readily by condensing the hydrophobic organic compound with ethylene/propylene oxide or with the polyhydration product thereof, polyethylene/polypropylene glycol. Further, the length of the polyethenoxy/polypropenoxy chain can be adjusted to achieve the desired balance between the hydrophobic and hydrophilic elements.

The satisfactory non-ionic detergents include the condensation products of a higher alkanol containing about 8 to 18 carbon atoms, saturated or unsaturated, in a straight- or branched-chain configuration condensed with about 3 to 30 moles of ethylene/propylene oxide. Examples of these detergents are the condensates of a dodecyl, tridecyl, tetradecyl, hexadecyl alkanol and mixtures thereof with from three to ten moles of ethylene oxide, e.g., condensates of C₉-C₁₁ alkanol with 5.7 moles of ethylene oxide, condensates of C₈-C₁₀ alkanol with 5 moles of ethylene oxide, condensates of C₁₀-C₁₄ alkanol with 6 moles of ethylene oxide, condensates of C₁₀-C₁₈ alkanol with 7 moles of ethylene oxide and C₁₀-C₁₈ alkanol with 8 moles of ethylene oxide.

Other satisfactory non-ionic detergents are the polyethylene/polypropylene oxide condensates of one mole of alkyl phenol containing from about 6 to 15 carbon atoms, saturated or unsaturated, in a straight- or branched-chain configuration with about 3 to 30 moles of ethylene/propylene oxide. Specific examples are nonyl phenol condensed with 9 moles of ethylene oxide, nonyl phenol condensed with 12 moles of ethylene oxide, dodecyl phenol condensed with 15 moles of ethylene oxide and dinonyl phenol condensed with 15 moles of ethylene oxide. Further suitable detergents are the water-soluble condensation products of C₈-C₁₈ alkanols with a heteric mixture of ethylene oxide and propylene oxide in a weight ratio of ethylene oxide to propylene oxide in the range of 5:1 to 1:5 with the total alkylene oxide content being 60-85% by weight of the molecule. Specific examples of such detergents are C₉-C₁₁ alkanol condensed with a mixture of 5 moles of ethylene oxide and 4 moles of propylene oxide, C₉-C₁₁ alkanol condensed with 3 moles of ethylene oxide and 2 moles of propylene oxide and the condensation product of C₉-C₁₁ alkanol with a mixture of 4 moles of ethylene oxide and 5 mols of propylene oxide.

Other non-ionic detergents may be alkyldimethyl-amineoxide, di-alkyl-methylamineoxide, alkylamidopropyl-amine oxide, fatty acid-N-methylglucamide, alkylpolyglucoside, oxalkylated fatty acid, oxalkylated fatty acid ester, oxalkylated alkylamine, sorbitol esters, oxalkylated sorbitol esters, sorbitan esters, oxalkylated sorbitan esters. The alkyl and fatty acid groups of these compounds, which also may be fully or partially replaced by the corresponding unsaturated groups, may contain 8 to 22 carbon atoms and may be linear or branched. Oxalkylated means products that contain preferably 1 to 20 units of ethylene oxide or propyleneoxide or mixtures thereof.

The claimed solid softener may contain these non-ionic compounds in an amount from 1 to 20% by weight of the entire formulation.

Preferred components for the fatty system are fatty alcohols and/or long-chain fatty acids or salts of long-chain fatty acids, for example those having sodium, potassium, aluminium, magnesium, titanium, ammonium, triethanolamine, diethanolamine and/or monoethanolamine as cation. The fatty alcohol can be cetyl alcohol, stearyl alcohol, or a mixture of both at any ratio, preferably 50:50, 30:70 or 70:30. Fatty esters, for example cetyl-palmitate and stearyl-palmitate, can also be used.

Other suitable components for the fatty system are erythritol esters, pentaerythritol esters, for example erythritol monoestearate, erythritol diestearate, pentaerythritol monoestearate and pentaerythritol diestearate. Glycerol esters, such as glycerol monoestearate and glycerol diestearate.

The fatty system is preferably used in amounts of from 0.5 to 8% by weight of the entire formulation.

Depending on the intended use, the formulations according to the invention comprise, in addition to the mentioned systems, additives and auxiliaries which are customary and specific in each case, for example enzymes, preservatives, fragrances and dyes, and sequestering agents.

Suitable enzymes are those from the class of proteases, lipases, amylases, cellulases and their mixtures. The enzymes can be adsorbed to carrier substances and/or protected by coating substances.

Suitable preservatives are, for example, phenoxyethanol, formaldehyde solution, pentanediol, isothiazolinones, benzoisothiazolines or sorbic acid.

The claimed product may have natural, synthetic and/or long-lasting fragrances.

Typical individual examples of other additives are sodium borate, RAED, stilbene compounds, toluenesulfonate, cumenesulfonate, xylenesulfonate, soaps and silicones.

The products according to the invention are notable for very good storage stability and also softening performance.

The solid softener compositions according to this invention are preferably obtained as a powder. They are preferably made in the following way:
(1) mixing in a mechanical mixer under heating and stirring the cationic compound, the solubilizing system and the fatty system (when present);
(2) adding the mixture obtained in step (1) to the carrier system which has been heated at nearly the same temperature as the first mixture;
(3) stirring until a powder is reached;
(4) drying (if necessary) and cooling to room temperature.

The mixture in step (1) is generally heated to such a temperature in order to get a completely fluid liquid.

The solid softener compositions according to this invention can also be prepared in the form of granules or tablets. One of the alternatives for production of both is to subject the powder, produced from the general procedure presented above, to a subsequent granulation or extrusion process.

The examples below serve to illustrate the invention in more detail without limiting it thereto. All amounts are given as % (w/w) of the entire composition.

### EXAMPLES

I) Solid Softener Composition (% by weight)
A) 6.5 Dialkanoylethyl-hydroxyethyl-methyl-ammonium methosulphate in ethanol (85% a.m.) (Praepagen® TQL-E)
B) 7.5 Propyleneglycol
C) 4.3 C₁₂-C₁₄-lauryl-alcohol ethoxylated with 8 mols of EO (Genapol® C080)
D) 56.1 Saccharose
E) 24.0 Corn Starch
F) 1.0 Silicon Dioxide
G) Dyestuff qs
H) Perfume qs
   Procedure:
I. Heat A in order to get a molten material (approx. 60° C.), under stirring.
II. Mix B and C with A under stirring and heating. Heat it till approx. 50° C.
III. Cool the mixture to room temperature and add G under stirring (mixture 1).
IV. Heat mixture 1 till approx. 50° C.
V. Heat D, E and F till 60° C. and add mixture 1 to them.
VI. Stir until reach a powder form.
VII. Cool to room temperature and add H.

II) Solid Softener Composition (% by weight)
A) 6.1 Dialkanoylethyl-hydroxyethyl-methyl-ammonium methosulphate in isopropanol (90% a.m.) (Praepagen® TQ)
B) 6.7 Propyleneglycol
C) 4.3 C₁₂-C₁₄-lauryl-alcohol ethoxylated with 8 mols of EO (Genapol® C080)
D) 0.8 Ceto-Stearyl Alcohol (50:50)
E) 56.1 Saccharose
F) 24.0 Corn Starch
G) 1.0 Silicon Dioxide
H) Dyestuff qs
I) Perfume qs
   Procedure:
I. Heat A in order to get a molten material (approx. 60° C.), under stirring.
II. Mix B, C and D with A under stirring and heating. Heat it till approx. 50° C.
III. Cool the mixture to room temperature and add H under stirring (mixture 1).
IV. Heat mixture 1 till approx. 50° C.
V. Heat E, F and G till 60° C. and add mixture 1 to them.
VI. Stir until reach a powder form.
VII. Cool to room temperature and add 1.

III) Solid Softener Composition (% by weight)
A) 8.2 Dialkanoylethyl-hydroxyethyl-methyl-ammonium methosulphate in isopropanol (85% a.m.) (Praepagen® TQL)
B) 9.5Propyleneglycol
C) 5.4C₁₂-C₁₄-lauryl-alcohol ethoxylated with 7 mols of EO (Genapol® C070)
D) 38.1 Saccharose
E) 38.1 Sodium Carbonate
F) Dyestuff qs
G) Perfume qs
   Procedure:
I. Heat A in order to get a molten material (approx. 60° C.), under stirring.
II. Mix B and C with A under stirring and heating. Heat it till approx. 50° C.
III. Cool the mixture to room temperature and add F under stirring (mixture 1).
IV. Heat mixture 1 till approx. 50° C.
V. Heat D and E till 60° C. and add mixture 1 to them.
VI. Stir until reach a powder form.
VII. Cool to room temperature and add G.

IV) Solid Softener Composition (% by weight)
A) 9.3Dialkyl-dimethyl-ammonium chloride in ethanol (75% a.m.) (Praepagen® WB)
B) 8.4Propyleneglycol
C) 5.4C₁₂-C₁₄-lauryl-alcohol ethoxylated with 8 mols of EO (Genapol® C080)
D) 37.6 Saccharose
E) 37.6 Corn Starch
F) 1.0 Silicon Dioxide
G) Dyestuff qs
H) Perfume qs
   Procedure:
I. Heat A in order to get a molten material (approx. 60° C.), under stirring.
II. Mix B and C with A under stirring and heating. Heat it till approx. 50° C.
III. Cool the mixture to room temperature and add G under stirring (mixture 1).
IV. Heat mixture 1 till approx. 50° C.
V. Heat D, E and F till 60° C. and add mixture 1 to them.
VI. Stir until reach a powder form.
VII. Cool to room temperature and add H.

1. A solid softener composition comprising:
a) A cationic compound of the formula: 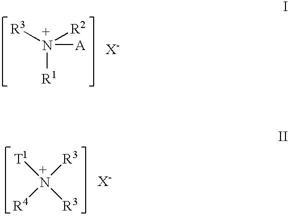
wherein:
A is a group of the formulas —(CH₂)n-Q-T¹ or 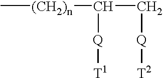
Q is selected from —O—C(O)—, —C(O)—O—, —O—C(O)—O—, —NR⁵—C(O)—, —C(O)—NR⁵—;
R¹ is (CH₂)n-Q-T² or T³ or R³;
R² is (CH₂)m-Q-T⁴ or T⁵ or R³;
R³is H, C₁-C₆ alkyl, C₂-C₆ alkenyl or C₁-C₆ hydroxyalkyl;
R⁴ is T¹, T², T³, T⁴ or T⁵;
R⁵is H, C₁-C₆-alkyl, C₂-C₆-alkenyl or C₁-C₆-hydroxyalkyl;
T¹, T², T³, T⁴, T⁵ are independently C₈-C₂₂-alkyl or C₈-C₂₂-alkenyl;
n and m are integers from 1 to 6; and
X⁻ is a softeners-compatible anion selected from the group consisting of chloride, bromide, iodide, fluoride, sulfate, methosulfate, hydrogensulfate, carbonate, hydrogencarbonate, phosphate, mono- and di-hydrogenphosphate, pyrophosphate, metaphosphate, nitrate, phosphonate, methylphosphonate, methandisulfonate, methylsulfonate, ethansulfonate, and mixtures thereof,
b) A carrier system selected from the group consisting of one or more organic solid material, at least one inorganic solid, and mixtures thereof,
c) A solubilizer system selected from the group consisting of one or more solvents, at least one nonionic surfactant, and mixtures thereof,
d) Optionally a fatty system selected from the group consisting of fatty alcohols, fatty acids, fatty esters, and mixtures thereof.

2. The solid softener composition as claimed in claim 1, wherein said solid softener comprises two or more different cationic compounds defined in claim 1(a).

3. The solid softener composition according to claim 1, wherein in formula I
Q is —O—C(O)—;
R¹ is (CH₂)n-Q-T² or T³ or R³;
R² is (CH₂)m-Q-T⁴ or T⁵ or R³;
R³ is C₁-C₆-alkyl, C₂-C₆-alkenyl or C₁-C₆-hydroxyalkyl;
T¹, T², T³, T⁴, T⁵ are independently C₈-C₂₂-alkyl or C₈-C₂₂-alkenyl;
n and m are 1 or 2.

4. The solid softener composition according to claim 1, wherein in formula II
R⁴is T¹;
T¹ is C₁₂-C₁₈-alkyl;
R³ is methyl.

5. The solid softener composition of claim 1, wherein the cationic compound comprises from 1 to 40% by weight of the solid softener composition.

6. The solid softener composition of claim 1, wherein the organic portion of the carrier system is composed of a high water soluble organic carrier, and a water dispersible organic carrier within the respective proportions of 10:90 to 90:10.

7. The solid softener composition of claim 1, wherein the inorganic solid material of the carrier system is silicon dioxide.

8. The solid softener composition of claim 1, wherein the proportion of organic and inorganic solid materials in the carrier system is within the respective proportions of 99:1 to 20:80.

9. The solid softener composition of claim 1, wherein the carrier system comprises from 50 to 99% by weight of the solid softener composition.

10. The solid softener composition of claim 1, wherein the solvents present in the solubilizer system are alcohols or lower alkyl ethers of ethylenglycol, propylenglycol, polyethylenglycol and polypropylenglycol.

11. The solid softener composition of claim 1, wherein the nonionic surfactant is a C₁₂-C₁₈ alcohol ethoxylated with 6 to 10 mols of ethylene oxide.

12. The solid softener composition of claim 1, wherein the solvents present in the solubilizer system comprise from 1 to 15% by weight of the solid softener composition.

13. The solid softener composition of claim 1, wherein the nonionic surfactants present in the solubilizer system comprise from 1 to 20% by weight of the solid softener composition.

14. The solid softener composition of claim 1, wherein Ceto-Stearylic Alcohol 30:70 or 50:50 is present in a concentration of 0.5 to 8% by weight of the entire formulation.

15. The solid softener composition of claim 1, which additionally contains further additives, auxiliaries and/or adjuvants.

16. The solid softener composition of claim 1, wherein the additive is an electroneutral complex formed by the association of a cationic and an anionic surfactant.

17. The solid softener composition of claim 1, in a form selected from the group consisting of powder, granules, tablets, and packed in water soluble sachets.

18. A method for production of the solid softener composition of claim 1 said method comprising mixing the cationic compound and the solubilizer system with the carrier system in order to get a flowable powder as final product.

19. A method for application of the solid softener composition of claim 1, in which the composition is applied in the rinsing cycle, by dispenser or any other way, in an automatic or manual process.

20. The solid softener composition of claim 1, wherein the cationic compound comprises from 2 to 20% by weight of the solid softener composition.

21. The solid softener composition of claim 6, wherein the high water soluble organic carrier is saccharose

22. The solid softener composition of claim 6, wherein the water dispersible organic carrier is corn starch.

23. The solid softener composition of claim 1, wherein the carrier system comprises from 70 to 95% by weight of the solid softener composition.

24. The solid softener composition of claim 1, in the form of a water soluble packet made of polyvinylalcohol.

25. The method of claim 18, further comprising drying said mixture.

26. A method for treating textiles in automatic or manual washing processes comprising a rinsing step, said method comprising adding to the rinsing step the solid softening composition of claim 1.
